(19) United States
(12) Patent Application Publication
(10) Pub. No.: US 2019/0287145 A1
(43) Pub. Date: Sep. 19, 2019

(54) RULE-BASED AUTOMATED RETAIL PRODUCT LINE LINKAGE

(71) Applicant: Walmart Apollo, LLC, Bentonville, AR (US)

(72) Inventors: Abhishek Mungoli, Haldwani (IN); Shilpy Dua, Manimajra (IN); Madhur Sarin, Gurgaon (IN)

(21) Appl. No.: 16/298,831

(22) Filed: Mar. 11, 2019

Related U.S. Application Data
(60) Provisional application No. 62/670,522, filed on May 11, 2018.

(30) Foreign Application Priority Data
Mar. 19, 2018 (IN) 201841009932

(51) Int. Cl. G06Q 30/02; G06F 16/906

(52) U.S. Cl. CPC G06Q 30/0283; G06F 16/906

(57) ABSTRACT

Systems, apparatuses, and methods are provided herein for rule-based automated retail product line linkage. The control circuit is configured to retrieve product data for a new product, comprising product categorical data, product numerical data, and product description data, and calculate unified line scores for each of the plurality of product lines in the product line database based on a categorical data score, a numerical data score, and a description data score. The control circuit is further configured to determine whether the new product corresponds to a new product line based on the unified line scores of the plurality of product lines and select a matching product line from the plurality of product lines for the new product based on the unified line scores of each of the plurality of product lines.

### CROSS-REFERENCE TO RELATED APPLICATION(S)

This application claims the benefit of the following Indian Provisional Application 201841009932 filed Mar. 19, 2018 and the following U.S. Provisional Application No. 62/670,522 filed May 11, 2018, both of which contents are incorporated herein by reference in their entireties.

### TECHNICAL FIELD

This invention relates generally to automated systems for retail management.

### BACKGROUND

A retail store typically offers a variety of products from various manufacturers and suppliers. Conventionally, at a retail store, products offered for sale are organized and priced manually.

### BRIEF DESCRIPTION OF THE DRAWINGS

Disclosed herein are embodiments of apparatuses and methods for rule-based retail product line linkage. This description includes drawings, wherein:

FIG. 1 comprises a system diagram in accordance with several embodiments;

FIG. 2 comprises a flow diagram in accordance with several embodiments;

FIG. 3 comprises a process diagram in accordance with several embodiments; and

FIG. 4 comprises a flow diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for rule-based automated retail product line linkage. In some embodiments, a system for rule-based automated retail product line linkage comprises a product line database comprising product line data for a plurality of product lines, wherein product line data comprises line categorical data, line numerical data, and line description data and a control circuit coupled to the product line database. The control circuit being configured to retrieve product data for a new product, the product data comprises product categorical data, product numerical data, and product description data, calculate unified line scores for each of the plurality of product lines in the product line database. Wherein a unified line score for a product line is determined with a rule-based scoring engine configured to: determine a categorical data score by comparing the product categorical data and the line categorical data associated with the product line according to a first rule, determine a numerical data score by comparing the product numerical data and the line numerical data associated with the product line according to a second rule, determine a description data score by comparing the line description data associated with the product line and the product description data according to a third rule, and combine the categorical data score, the numerical data score, and the description data score according to a fourth rule to generate the unified line score for the product line. The control circuit is further configured to determine whether the new product corresponds to a new product line based on the unified line scores of the plurality of product lines, and in the event that the new product does not correspond to a new product line, select a matching product line from the plurality of product lines for the new product based on the unified line scores of each of the plurality of product lines, update the product line database to associate the new product with the matching product line; and enforce pricing consistency rules for products within each product line in the product line database.

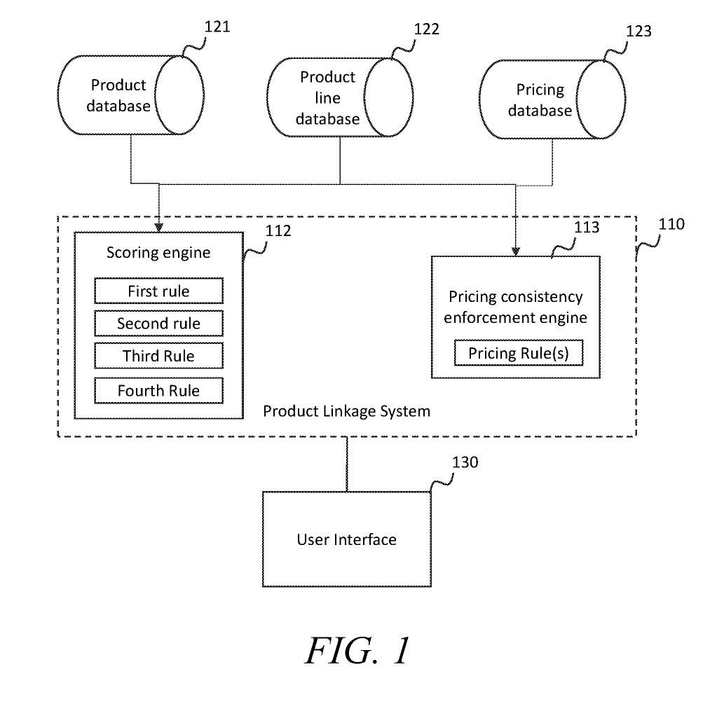

Referring now to FIG. 1, a product line linkage system is shown. The system comprises an item linkage system 110, a product database 121, a product line database 122, a pricing database 123, and a user interface device 130. The item linkage system 110 comprises a scoring engine 112 and a pricing consistency enforcement engine 113.

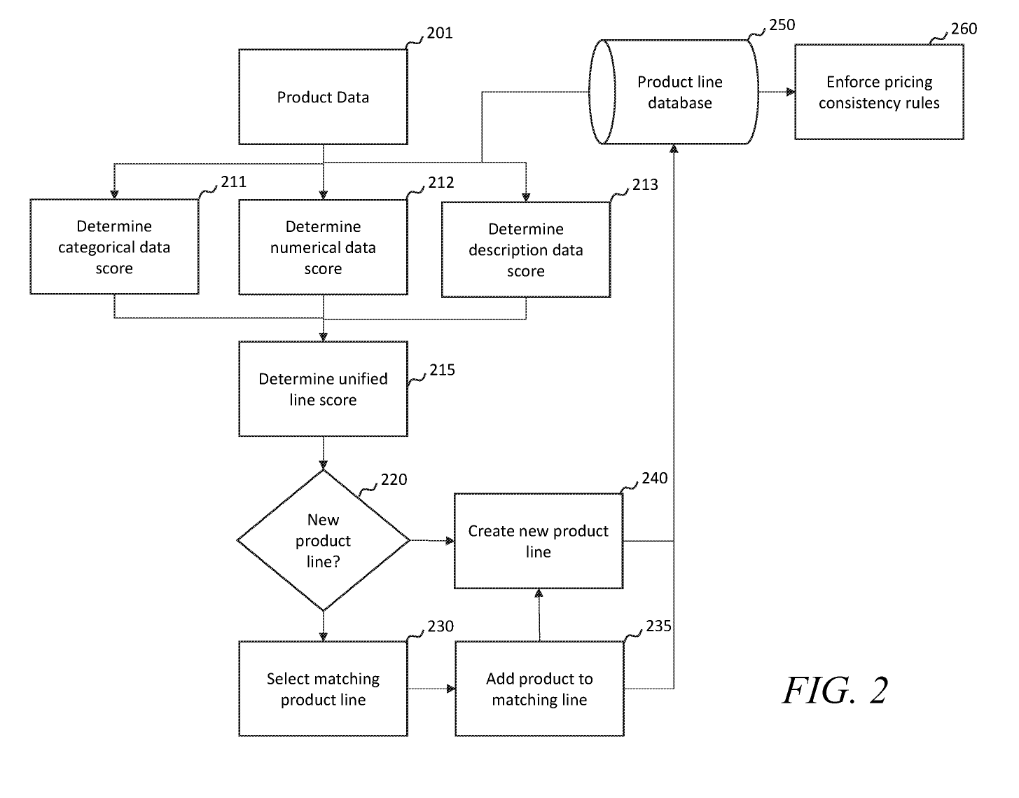

The item linkage system 110 may refer to a merchant backend system that processes item information and automatically links products with product lines based on predefined rules. In some embodiments, the item linkage system 110 may comprise a processor-based system, a server device, a cloud-based server, a networked computer, etc. In some embodiments, the item linkage system 110 may serve a specific store location or comprise a central server system that serves a plurality of geographically dispersed store locations. The item linkage system 110 may comprise one or more processor-based devices comprising at least a control circuit and a memory device. In some embodiments, the item linkage system 110 may further comprise a network adapter configured to communicate with one or more of the product database 121, the product line database 122, and the pricing database 123, and the user interface device 130 over a network such as a private network, a local area network, and the Internet. The control circuit of the item linkage system 110 may comprise a processor, a microprocessor, a microcontroller, and the like and is configured to execute computer-readable instructions stored in a computer-readable storage memory. The computer-readable storage memory may comprise volatile and/or non-volatile memory and have stored upon it a set of computer-readable instructions which, when executed by the control circuit, causes the control circuit to communicate with one or more of the product database 121, the product line database 122, the pricing database 123, and the user interface device 130 to determine product linkage and/or enforce pricing rules. In some embodiments, the control circuit of the item linkage system 110 may be configured to perform one or more steps described with reference to FIGS. 2-4 herein.

The item linkage system 110 comprises a scoring engine 112 and a pricing consistency enforcement engine 113. In some embodiments, the scoring engine 112 and the pricing consistency enforcement engine 113 may be implemented as software and/or hardware modules on one or more physical devices in the item linkage system 110. The scoring engine 112 is generally configured to link products in the product database 121 with lines in the product line database 122. In some embodiments, a product may comprise items with the same product identifier (e.g. stock keeping unit (SKU), Universal Product Code (UPC)). In some embodiments, a product refers to items for sale that are essentially fungible with each other, having the same package size, being the same variety, etc. A product line generally refers to a group of products that are closely associated and should be priced consistently. A product line may comprise similar items offered in different flavors (e.g. ranch vs. BBQ chips), colors (e.g. light brown vs. medium brown hair color), varieties (e.g. regular vs. light yogurt), etc. In some embodiments, products in the same line may generally be provided by the same manufacturer, sold under the same brand, label, trademark etc. The scoring engine 112 is configured to calculate line scores based on product information from the product database 121 and product line information from the product line database 122. The scoring engine 112 may be configured to execute a first rule to determine a categorical data score, a second rule to determine a numerical data score, and a third rule to determine a description data score. In some embodiments, the first rule comprises weighting rules for two or more features of categorical data. In some embodiments, the second rule comprises an equation for determining a distance metric between the line numerical data and the product numerical data. In some embodiments, the third rule comprises a cosine similarity comparison algorithm for bag of words. The scoring engine 112 may further be configured to combine the three scores to determine a unified line score for a plurality of lines based on a fourth rule. In some embodiments, the fourth rule comprises a weighing rule for combining the categorical data score, the numerical data score, and the description score into a unified line score. In some embodiments, one or more of the first rule, the second rule, the third rule, and the fourth rule may be specific to product category and/or department. For example, the first rule for linking cosmetic products may be different from the first rule for linking apparels. The difference may be in the selection of input data, the scoring equation, parameters of the scoring equation and/or the weighting of different components of the score. Further details of item linkage and the scoring engine 112 are described with reference to FIGS. 2-4 herein.

The pricing consistency enforcement engine 113 is generally configured to perform pricing consistency checks based on the product groupings in the product line database 122 and item prices in the pricing database 123. The pricing consistency enforcement engine 113 may check prices of products against one or more pricing rules applicable to the products. For example, a pricing rule may specify that products in the same line (e.g. flavors of a potato chip) that are of the same size/unit count should be priced the same. In some embodiments, pricing consistency checks may be performed on current prices of product and/or planned prices for future adjustments/sales, etc. When a pricing rule violation is detected by the pricing consistency enforcement engine 113, the system may tag the product for adjustment in the pricing database 123 and/or generate an alert through the user interface device 130.

The user interface device 130 may comprise one or more devices configured to allow human operators to interact with the item linkage system 110. The user interface device 130 may comprise a processor-based device comprising at least a control circuit and a memory device. The control circuit of the user interface device 130 may comprise a processor, a microprocessor, a microcontroller, and the like and is configured to execute computer-readable instructions stored in a computer-readable storage memory. The computer-readable storage memory may comprise volatile and/or non-volatile memory and have stored upon it a set of computer-readable instructions which, when executed by the control circuit, causes the control circuit to provide a user interface to interact with the item linkage system 110. In some embodiments, the item linkage system 110 may be accessed through a web browser and the user interface may comprise a webpage. In some embodiments, the user interface device 130 may execute a computer program configured to provide one or more functions described herein. In some embodiments, the user interface device 130 may comprise one or more user input/output devices such as a display screen, a keyboard, a touch screen, a speaker, a microphone, an optical scanner, an RFID scanner, a camera, etc. In some embodiments, users may use the user interface 130 to capture/enter product data into the product database 121. In some embodiments, product data may be supplied by manufacturers and/or suppliers. In some embodiments, the user interface device 130 may be configured to display item linkage information and pricing information to users. In some embodiments, the user interface device 130 may be configured to display the result of the scoring engine 112 and/or the pricing consistency enforcement engine 113 to the users to allow the user to configure one or more rules used by the system. In some embodiments, the user interface device 130 may further be configured to allow users to adjust product linkage and/or pricing after the automated determination is made by the system. In some embodiments, the user interface device 130 may communicate with the item linkage system 110 via a wired connection, a wireless connection, a networked connection, a local area network, a private network, the Internet, etc. While only one user interface device 130 is shown, in some embodiments, the item linkage system 110 may be configured to communicate with a plurality of user interface devices 130. For example, multiple user interface devices 130 may use the item linkage system 110 to perform item linkage and price verification for different store departments (e.g. cosmetics, grocery, etc.).

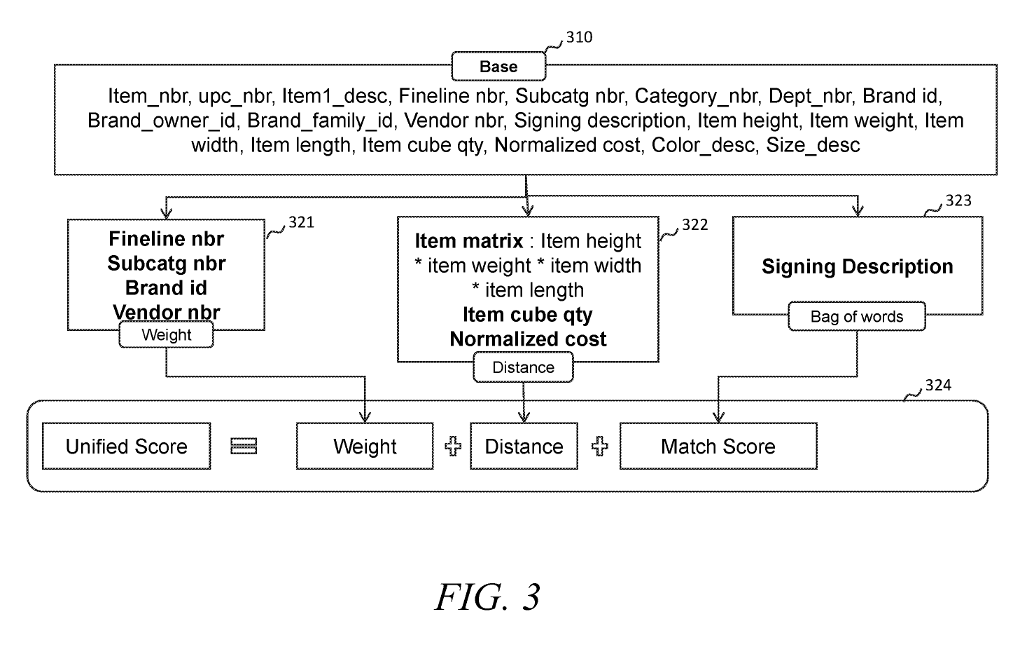

The product database 121 generally refers to a computer-readable memory device configured to store product information. Product data may comprise product categorical data, product numerical data, and product description data. In some embodiments, product categorical data comprises one or more of a brand identifier, a vendor identifier, a fineline number, and a department subcategory number. In some embodiments, product numerical data comprises one or more of package count, weight, volume, height, width, and length. In some embodiments, product description data comprises text descriptions. In some embodiments, the product database 121 may store information supplied by manufacturers, product specification, product package information, product characteristics, etc. The product database 121 may store information for each unique product offered for sale, differentiating between items with different package sizes, variety, flavor, color, etc. In some embodiments, the products having different unique product identifiers (e.g. stock keeping unit (SKU), Universal Product Code (UPC)) may have different entries in the product database 121. Several examples of product data are described with reference to FIG. 3 and Table 1 herein.

The product line database 122 generally refers to a computer-readable memory device configured to store product line grouping information. Product line data may comprise line categorical data, line numerical data, and line description data. In some embodiments, line categorical data, line numerical data, and line description data of a product line may correspond to product categorical data, product numerical data, and product description data of a representative product in the product line. In some embodiments, the product line database 122 may further store characteristics associated with each line such as associated product category, common characteristics, representative product, line-specific pricing rules, line-specific scoring rules, category-specific scoring rules, etc. In some embodiments, the product line database 122 may be combined with the product database instead of being implemented as a separate database. For example, product line identifier may be added to product data in the product database 121 once a product is linked to a group.

The pricing database 123 generally refers to a computer-readable memory device configured to store product pricing information. In some embodiments, the pricing database 123 may store current and/or planned prices for a plurality of products offered for sale in one or more physical and/or online stores. In some embodiments, one or more of the product database 121, the product line database 122, and the pricing database 123 may be implemented as separate or shared physical memory devices and/or digital databases.

Referring now to FIG. 2, a method for a product linkage is shown. In some embodiments, the steps shown in FIG. 2 may be performed by a processor-based device such as one or more of retailer management system, a retailer backend system, a central computer system, a server, a cloud-based server, etc. In some embodiments, the steps in FIG. 2 may be performed by the item linkage system described with reference to FIG. 1 herein or similar devices.

In step 201, the system receives product data for a new product. A new product may refer to a product not yet linked to a product line. Product data may comprise product categorical data, product numerical data, and product description data. In some embodiments, the system is further configured to categorize product data received from the supplier/manufacturer and/or from product packaging into one of the three types of data: categorical, numerical, and description. Categorical data generally refers to data that indicates the product's category and may comprise data such as the product's fineline number, subcategory number, brand identifier, vendor identifier, etc. A fineline number refers to a retailer assigned number which links a group of items within a department which show similar sales patterns. Numerical data generally refers to data that corresponds to the product's physical properties such as item matrix, item height, item weight, item width, item length, item cube quantity, item volume, normalized cost, etc. Description data may generally refer to other text descriptions of the product such as color description, size description, flavor description, etc. After product data are separated into data types, a rule-based scoring engine proceeds to steps 211, 212, and 213 to determine unified line scores between the new product and a plurality of product lines.

In step 211, the rule-based scoring engine determines a categorical data score. The categorical data score is determined by comparing the product categorical data and a line categorical data associated with the product line according to a first rule. The first rule may comprise determining whether there is a match between each data item (e.g. category identifier, brand identifier, manufacturer identifier, etc.) and assigning weight to each match. For example, matching brand identifiers between the product line and the new product may add 1 to the score and matching category identifiers may add 0.5 to the score. In some embodiments, the relative weights of each matching data item and/or data items included in the calculation may be determined by the first rule. In some embodiments, the first rule may be selected from a plurality of rules based on the category of the new product and/or the product line being compared.

In step 212 the rule-based scoring engine determines a numerical data score. The numerical data score may be determined by comparing the product numerical data and the line numerical data associated with the product line according to a second rule. In some embodiments, the categorical data score is determined by calculating a distance between the numerical data values of the product and the line. For example, the numerical data score for a product having a product matrix (M_{P}) and a product line having a line matrix (M_{L}) may be calculated based on Score=1/(1+(M_{P}−M_{L})) or Score=1/(1+root (M_{P}−M_{L})). The equation for calculating the score and the data items used for calculating the score may be specified in the second rule. In some embodiments, the second rule may be selected from a plurality of rules based on the category of the new product and/or the product line being compared.

In step 213, the rule-based scoring engine determines a description data score. The description data score may be determined by comparing the line description data associated with the product line and the product description data according to a third rule. In some embodiments, the description data score is determined using a bag of word comparison method. For example, the system may give a point to each matching word in the description of the product and the line and normalize the score based on the total number of words to determine a description data score.

In step 215, the rule-based scoring engine determines a unified line score. The unified line score for each product line may be generated by combining the categorical data score, the numerical data score, and the description data score according to a fourth rule. In some embodiments, the three scores may be added to generate the unified line score. In some embodiments, the fourth rule may specify the weighting between the categorical data score, the numerical data score, and the description data score. Steps 211-215 may generally be repeated for a plurality of product lines in the product line database 250 before proceeding to step 220.

In step 220, the system determines whether the new product belongs to a new product line based on the unified line scores for a plurality of product lines determined in step 215. In some embodiments, step 220 may be determined based on whether any of the unified product lines exceeds a threshold score. In some embodiments, step 220 may be determined based on whether a particular line's unified line score exceeds the other line scores by a predetermined margin. In some embodiments, step 220 may be based on anomaly detection. In some embodiments, the threshold and/or margin for determining whether a new product belongs to a new line may be category-specific.

If the new product is determined to belong to a new product line, in step 240, the system creates a new product line in the product line database 250 and adds the new product to the newly created line. In some embodiments, the system may generate a new product line identifier in step 240 and may assign the new product as the representative product in the new product line. In some embodiments, the new product line may be subject to human operator review prior to being added to the product line database.

If the new product does not correspond to a new product line, in step 230, the system selects a matching product line from the plurality of product lines for the new product based on the unified line scores of each of the plurality of product lines. The matching product line generally corresponds to the product line with the highest product line score. In step 235, the product is added to the matching line in the product line database 250. In some embodiments, the product's line identifier may be added to the product's data in a product database.

In step 260, the system then uses the information in the product line database 250 to enforce pricing consistency rules. In some embodiments, the system may enforce pricing consistency rules for products within each product line in the product line database. In some embodiments, a pricing consistency enforcement engine may be configured to perform pricing consistency checks based on the product groupings in the product line database and item prices in the pricing database. The pricing consistency enforcement engine may check the prices against one or more predefined pricing rules. For example, a pricing rule may specify that products in the same line (e.g. flavors of a potato chip) that are of the same size/unit count should be priced the same. Another example of a pricing rule may specify that for products in a line, larger package size (e.g. a gallon of C brand ice cream) should be priced higher than smaller package sizes (e.g. a quart of C brand ice cream). In some embodiments, pricing consistency checks may be performed on current prices of product and/or planned prices for future adjustments/sales, etc. When a pricing inconsistency is detected by the pricing consistency enforcement engine, the system may tag the product for adjustment in a product pricing database and/or generate an alert through a user interface.

The steps in FIG. 2 may be repeated for a plurality of products to add linkage information of new products to the product line database 250 and/or a product database. Existing product linkage information may then be used to determine linkage of additional products. In some embodiments, existing product linkage information may further be used to adjust the rules for determining one or more of categorical data score, the numerical data score, the description data score, and unified line score. In some embodiments, existing product linkage information may further be used to determine the threshold for anomaly detection in step 220. For example, the unified score varieties of products in an existing product line may be used to determine the threshold associated with the line and/or category.

Referring now to FIG. 3, an illustration of a unified score calculation is shown. FIG. 3 generally shows an example of converting product data and line data into a unified score to determine matches between a product and a product line. In some embodiments, the process shown in FIG. 3 may be performed by a processor-based device such as one or more of retailer management system, a retailer backend system, a central computer system, a server, a cloud-based server, etc. In some embodiments, the process in FIG. 3 may be performed by the item linkage system described with reference to FIG. 1 herein or similar devices.

The process begins with various base product data 310 received at the system. Examples of such data may comprise Item_nbr, upc_nbr, Item1_desc, Fineline nbr, Subcatg nbr, Category_nbr, Dept_nbr, Brand id, Brand_owner_id, Brand_family_id, Vendor nbr, Signing description, Item height, Item weight, Item width, Item length, Item cube qty, Normalized cost, Color_desc, Size_desc, etc. Generally, any product data supplied by the manufacturer or inputted by the retailer may be used. The available product data are categorized into categorical data 321, numerical data 322, and description data 323. Examples of categorical data 321 comprise Fineline nbr, Subcatg nbr, Brand id and Vendor nbr. Examples of numerical data 322 comprise Item matrix (e.g. Item height, item weight, item width, item length), Item cube qty, and Normalized cost. Examples of description data 323 comprise signing description.

Product data and line data in the categorical data category 321 are weighted to determine a weight value. In some embodiments, weight value comprises categorical data score and may be calculated based on step 211 described with reference to FIG. 2 herein. Product data and line data in the numerical data category 322 are compared to calculate a distance value. In some embodiments, distance value comprises numerical data score and may be calculated based on step 212 described with reference to FIG. 2 herein. Product data in the description data category 322 are compared based on a bag of words/cosine similarity method to determine a match score. In some embodiments, match score comprises description data score and may be calculated based on step 213 described with reference to FIG. 2 herein. A unified score 324 is then determined by combining the weight value, the distance value, and the match score. In some embodiments, the unified score may be determined based on step 215 described with reference to FIG. 2 herein.

The input data and data categorization in FIG. 3 are provided as an example only. In some embodiments, some product data may be omitted or added from the product data showing in FIG. 3. In some embodiments, different product data may be selected to calculate one or more of the weight value, the distance value, and the matching score based on the category of the product being compared.

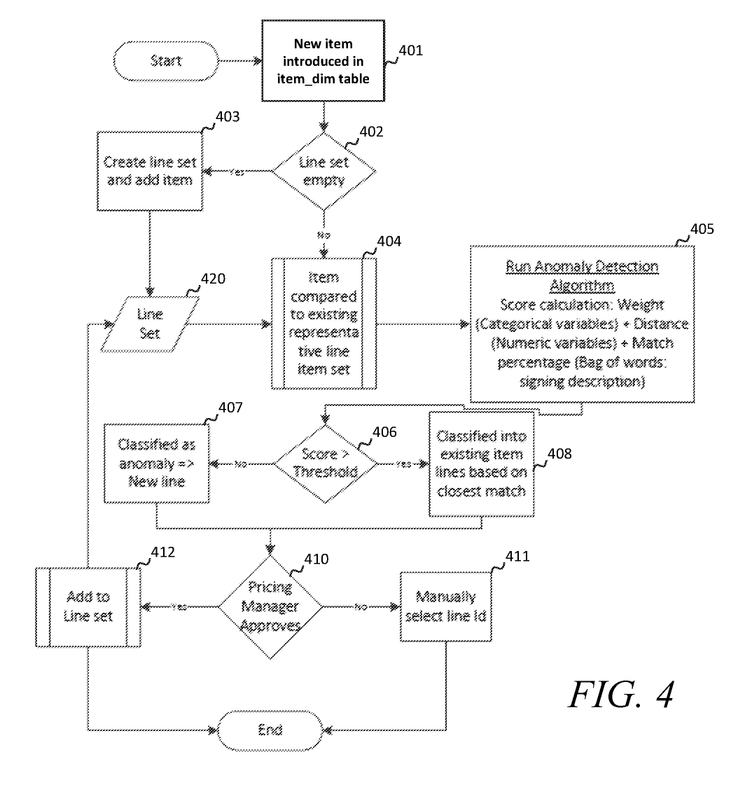

Referring now to FIG. 4, an illustration of a unified score calculation is shown. FIG. 4 generally shows an example of converting product data and line data into a unified score to determine matches between a product and a product line. In some embodiments, the steps shown in FIG. 4 may be performed by a processor-based device such as one or more of retailer management system, a retailer backend system, a central computer system, a server, a cloud-based server, etc. In some embodiments, the steps in FIG. 4 may be performed by the item linkage system described with reference to FIG. 1 herein or similar devices.

In step 401, a new item is introduced in the item_dim table. In step 402, the system determines whether the line set is empty. If the line set is empty, the process proceeds to step 403 to create a line set and add the item. The new line set information is added to the line set database 420. If the line set is not empty, the system proceeds to step 404 and the item is compared to one or more existing presentative line item sets. In step 405, the system runs an anomaly detection algorithm. In the anomaly detection algorithm, the system calculates a weight value based on categorical variables, a distance value based on numerical variables, and a match percentage score based on bag of words/cosine similarity in the signing description. Further details of step 405 are described in FIG. 2-3 and in the examples below.

In step 406, the system determines whether the unified scores determined in step 405 exceed a predetermined threshold. In some embodiments, the score used in step 406 may comprise the highest score among a plurality of product lines. For example, step 405 may be repeated for a plurality of product lines for the same product, and anomaly detection is performed based on the highest unified score. If the unified score exceeds a threshold, in step 408, the new item is classified into an existing item line based on the closest match (e.g. highest unified score). If the unified score does not exceed the threshold, in step 407, the new item is classified as an anomaly/new line. In step 410, a pricing manager approves the categorization automatically determined by the system. If the machine categorization is approved, in step 412 the new item is added to the line set 420. If the machine categorization is not approved in step 410, in step 411, the pricing manager may manually select a line ID for the product. Pricing manager's selection may then be stored in the line set 420.

An example pseudocode for item linkage and anomaly detection is provided below. The pseudocode is provided only as one example of implementing the concepts described herein in computer-executable code. The methods and systems described herein may be variously implemented on automated systems without departing from the spirit of the present disclosure.

1. Load training dataset
2. For categorical features create a function to compute weightage/importance of attributes
a. Function computeWeightage(attribute):
   i. ‘p’=Probability of items belonging to the same Line having same value for given attribute
   ii. return ‘p’// For eg. BRAND_ID may be same across all items belonging to same Line but VENDOR_ID may differ. As a result BRAND_ID will get higher importance/weightage than VENDOR_ID
      3. For attributes in
      [‘FINELINE_NBR’,‘DEPT_SUBCATG_NBR’,‘VENDOR_ID’,‘BRAND_ID’]://categorical features
b. Weightage[attribute]=computeWeightage(attribute)//finds how important given attribute is
   4. Create a derived feature ITEM_MATRIX to reduce inconsistency across data and reduce feature space.
c. ITEM_MATRIX=ITEM_LENGTH*ITEM_WIDTH*ITEM_HEIGHT
   5. For numerical features, create different distance metrics
d. function distanceCompute(value1,value2,sequence)://(i)-(iv) penalises distance less while (v)-(viii) distance more
   i. If (sequence==0):
      1. Denominator=1+absolute(value2−value1)
   ii. Else if(sequence==1):
      1. Denominator=1+sqrt(absolute(value2−value1))
   iii. Else if(sequence==2):
      1. Denominator=1+power(absolute(value2−value1),1/10)
   iv. Else if(sequence==3):
      1. Denominator=1+log(1+absolute(value2−value1))
   v. Else if(sequence==4):
      1. Denominator=exponentiation(−1*absolute(value2−value1))
   vi. Else if(sequence==5):
      1. Denominator=1+power(absolute(value2−value1),2)
   vii. Else if(sequence==6):
      1. Denominator=1+power(absolute(value2−value1),3)
   viii. Else if(sequence==7):
      1. Denominator=exponentiation(absolute(value2−value1))

Return (1/Denominator)

6. Matching algorithm to convert item matching into scores.
e. function match(testItem,trainItemSet):
   i. maxScore=0; score=0; matchedLine=NULL
   ii. For item in trainItemSet:
      1. For attributes in [‘FINELINE_NBR’,‘DEPT_SUBCATG_NBR’,‘VEND OR_ID’,‘BRAND_ID’]://categorical features
         a. If testItem matches item in attributes:
         i. score+=Weightage[attribute]
      2. For attribute in [‘Normalized_Cost’,‘ITEM_MATRIX’]:
         i. score+=distanceCompute(testItem[attribute],ite m[attribute],sequence)
      3. score+=cosineSimilarity(testItem[‘SigningDescription’], item[‘SigningDescription’])//Signing Description is a one-liner description about item
   iii. If (score>maxScore):
      1. Score=maxScore
      2. matchedLine=item[‘Line’]//This is the most probable Line till now
         7. Divide training dataset into
f. Single Line items
g. Multiple Line items
   8. Cross validate to find the best distance metric say ‘x’ using matching function from (6) on Multiple Line items from 7(b) which best separates // May vary across categories
   9. Run the matching algorithm from (6) selecting the distance metric ‘x’ from (8) on Single Line items from 7(a)
   10. Cross validate on scores from (8) & (9) to find a threshold that separates new line score with existing line score with >95% accuracy, say ‘threshold’
   11. Load test data
   12. Run the below algorithm for each item from test DataSet.
h. For testItem in test DataSet:
   i. score=0; maxScore=0; matchedLine=NULL
   ii. For item in train Dataset:
      1. score=match(item, testItem)
      2. if(score>maxScore):
         a. maxScore=score
         b. matchedLine=item[‘Line’]
i. If(maxScore>threshold):
   i. Return matchedLine
j. Else
   i. Return ‘Possible NewLine’ and add to Training DataSet

An example data set and calculations for determining product linkage is provided below.

TABLE 1
example data set

| | | | | | NORMAL- | | |
|---|---|---|---|---|---|---|---|
| | | | | | ISED | | |
| ITEM | FINELINE_NBR | DEPT_SUBCATG_NBR | VENDOR_ID | BRAND_ID | COST | ITEM_MATRIX | ITEM_DESCRIPTION |
| 1 | 41 | 72 | 37 | Garnier | 1.38 | 7.81 | Garnier Black |
| | | | | | | | Hair Color |
| 2 | 50 | 74 | 38 | Loreal | 1.27 | 5.41 | Loreal Silky |
| | | | | | | | Smooth |
| 3 | 41 | 72 | 37 | Garnier | 1.37 | 7.83 | Garnier Brown |
| | | | | | | | Hair color |
| 4 | 41 | 72 | 39 | Garnier | 1.39 | 7.79 | Garnier Instant |
| | | | | | | | Silky Black |
| 5 | 50 | 74 | 38 | Loreal | 1.25 | 5.39 | Loreal Gray |
| | | | | | | | Shine Color |
| 6 | 51 | 74 | 39 | Loreal | 1.26 | 5.37 | Loreal Bacardy |
| | | | | | | | Shine & Smooth |
| 7 | 54 | 72 | 38 | Procter | 1.52 | 5.58 | Procter Black |
| | | | | | | | with Almonds |
| 8 | 55 | 72 | 39 | Prestige | 1.48 | 6.21 | Prestige Hair |
| | | | | | | | Specialist Brown |
| 9 | 54 | 72 | 38 | Procter | 1.37 | 5.32 | Procter Brown |
| | | | | | | | Hair Color |

The calculations below show the determination of a unified score between item 1 and item 3, treated as the representative item for line 3 according to the product data in table one. The sample data set and calculations are provided only as an example. The methods and systems described herein may be variously implemented without departing from the spirit of the present disclosure. For example, different input data and/or different rules may be used to calculate one or more values/scores shown below.

Finding Weightage for Categorical Features (Categorical Data Score):

| BRAND_ID = | BRAND_ID WEIGHT = 1 |
|---|---|
| (1 + 1 + 1 + 1)/4 = 4/4 = 1 | |
| VENDOR_ID = | VENDOR_ID WEIGHT = 0.75 |
| (½ + ½ + 1 + 1)/4 = 0.75 | FINELINE_NBR WEIGHT = 0.875 |
| FINELINE_NBR == | DEPT_SUBCATG_NBR WEIGHT = 1 |
| (1 + ½ + 1 + 1)/4 = 0.875 | |
| DEPT_SUBCATG_NBR = | |
| (1 + 1 + 1 + 1)/4 = 1 | |

Finding Distance for Numerical Features (Numerical Data Score):

| ITEM_MATRIX = 1/(1 + | For distance metric = 1 |
|---|---|
| (1.38 − 1.37)) = 0.99 | |
| ITEM_MATRIX == 1/(1 + | For distance metric = 2 |
| (7.81 − 7.83)) = 1.020 | |

Finding Cosine Similarity for Item_Description (Description Data Score): Comparing “Gamier Black Hair Color” and “Gamier Brown Hair Color” based on bag of words method.

| Gamier | Black | Brown | Hair | Color |
|---|---|---|---|---|
| 1 | 1 | 0 | 1 | 1 |
| 1 | 0 | 1 | 1 | 1 |

(1*1 + 1*0 + 0*1 + 1*1 + 1*1)/(root(4) * root(4)) = ¾
Matching Score = 0.75

Finding the Unified Score between Item 1 and a line represented by item 3:

Unified score=(1+0.75+0.875+1)+(0.99+1.020)+0.75=6.385

The following table shows the unified scores between item 1 and each of items 2-9 in Table 1 being used as representative items in a respective line.

TABLE 2
Unified Scores between item 1 and other lines

| Line | Unified Score |
|---|---|
| 2 | 1.1950185 |
| 3 | 6.3855072 |
| 4 | 5.3654932 |
| 5 | 1.4273534 |
| 6 | 1.1835548 |
| 7 | 2.7223882 |
| 8 | 2.7457265 |
| 9 | 2.776632 |

In the data set and calculations above, line 3 is determined to be the closest match to item 1. If the score of 6.3855072 is above a predetermined threshold, item 1 would be linked to line 3, represented by item 3. If the score of 6.3855072 is below a predetermined threshold score, then a new line may be created for item 1.

Price, assortment of offerings, and in-store experience are components that can create favorable customer perceptions, enhance customer trust and loyalty, and encourage return trips. Customers generally expect items with similar attributes to be priced consistently. For example, all shades of the same brand and type of hair color should have the same price. Likewise, similar items which differ only in package sizes should also be priced consistently. For example, smaller pack size should be priced lower than larger pack size. Pricing consistency forms an important part of maintaining price integrity. This attribution of items into groups may be referred to as item linking/grouping. The first form of groups of items with similar attributes is called item line, latter of pricing as per pack size is called Ladder. Lines, ladders, Private v/s National all form important parameters linking items for consistent pricing. Pricing managers are tasked with identifying appropriate item groups and implementing prices at that level as a rule. Conventionally, the process of creating item groups is manual, error-prone, and time-consuming.

In some embodiments, an item linkage system and methods described herein aim to standardize the item grouping process to achieve pricing consistency, adhere to pricing rules, save time, improve accuracy, transparency and thus enhance customer price perception. In some embodiments, anomaly detection is used to identify whether each newly added item offered for sale should form a new line (anomalous compared to existing sets of items and lines) or belong to one of the existing lines. Systems and methods described herein may incorporate anomaly detection algorithm and supervised machine learning. Anomaly Detection is generally applicable when a very few anomalous examples are available to train and test models (i.e. very few positive and many negative). Supervised learning generally works well when sufficient sets of both positive and negative examples are available, but may not be as effective in cases where only a few positives are available. Price could be derived from the group attributes including cost information using heuristics. However, this approach may require significant manual data scrubbing.

In some embodiments, systems and methods described herein make use of item attributes like item product dimensions, vendor, color, and size and seller hierarchy such as category, subcategory, and fineline, as data points for classifying items into lines. The system may first segregate variables by type into categorical, numeric and definitions. Normalized weights for each type of data are then calculated based on type-specific methods. The calculation of scores for each type of data may be a rule specific to the data type (e.g. probability for categorical, distance for numeric, and bag of words for definition). The system then creates a composite weight factor of an item using variables and weights associated with each type of data. When compared across training items, the closest weighted item is determined to be the most probable match. In some embodiments, new line detection may use a threshold calculated using the correctly predicted item lines to identify that the new item belongs to a new (anomalous) line.

In some embodiments, the systems and methods described herein use anomaly detection to calculate the threshold used to determine whether an item belongs to a new or existing line. In some embodiments, item and line features are classified for processing such as the processing of each type of variable is unique to its type. In some embodiments, feature weights are calculated dynamically based on the data. The significance of these feature weights may determine whether/how much they should affect the composite score. In some embodiments, scores associated with each data type are combined into a unified score for linkage and anomaly detection.

In some embodiments, a system for rule-based automated retail product line linkage comprises a product line database comprising product line data for a plurality of product lines, wherein product line data comprises line categorical data, line numerical data, and line description data and a control circuit coupled to the product line database. The control circuit being configured to retrieve product data for a new product, the product data comprises product categorical data, product numerical data, and product description data, calculate unified line scores for each of the plurality of product lines in the product line database. Wherein a unified line score for a product line is determined with a rule-based scoring engine configured to: determine a categorical data score by comparing the product categorical data and the line categorical data associated with the product line according to a first rule, determine a numerical data score by comparing the product numerical data and the line numerical data associated with the product line according to a second rule, determine a description data score by comparing the line description data associated with the product line and the product description data according to a third rule, and combine the categorical data score, the numerical data score, and the description data score according to a fourth rule to generate the unified line score for the product line. The control circuit is further configured to determine whether the new product corresponds to a new product line based on the unified line scores of the plurality of product lines, and in the event that the new product does not correspond to a new product line, select a matching product line from the plurality of product lines for the new product based on the unified line scores of each of the plurality of product lines, update the product line database to associate the new product with the matching product line; and enforce pricing consistency rules for products within each product line in the product line database.

In one embodiment, a method for rule-based automated retail product line linkage comprises retrieving product data for a new product, the product data comprising product categorical data, product numerical data, and product description data, retrieving product line data for a plurality of product lines from a product line database, wherein product line data comprises line categorical data, line numerical data, and line description data, and calculating, with a control circuit, unified line scores for each of the plurality of product lines in the product line database. A unified line score for a product line is determined with a rule-based scoring engine configured to determine a categorical data score by comparing the product categorical data and the line categorical data associated with the product line according to a first rule, determine a numerical data score by comparing the product numerical data and the line numerical data associated with the product line according to a second rule, determine a description data score by comparing the line description data associated with the product line and the product description data according to a third rule; and combine the categorical data score, the numerical data score, and the description data score according to a fourth rule to generate the unified line score for the product line. The method further comprises determining whether the new product corresponds to a new product line based on the unified line scores of the plurality of product lines, and in the event that the new product does not correspond to a new product line, selecting, with the control circuit, a matching product line from the plurality of product lines for the new product based on the unified line scores of each of the plurality of product lines, updating the product line database to associate the new product with the matching product line, and enforcing pricing consistency rules for products within each product line in the product line database.

In one embodiment, an apparatus for rule-based automated retail product line linkage comprises a non-transitory storage medium storing a set of computer-readable instructions and a control circuit configured to execute the set of computer-readable instructions which causes the control circuit to: retrieve product data for a new product, the product data comprising product categorical data, product numerical data, and product description data, retrieve product line data for a plurality of product lines from a product line database, wherein product line data comprises line categorical data, line numerical data, and line description data, and calculate unified line scores for each of the plurality of product lines in the product line database. A unified line score for a product line is determined with a rule-based scoring engine configured to determine a categorical data score by comparing the product categorical data and the line categorical data associated with the product line according to a first rule, determine a numerical data score by comparing the product numerical data and the line numerical data associated with the product line according to a second rule, and determine a description data score by comparing the line description data associated with the product line and the product description data according to a third rule, and combine the categorical data score, the numerical data score, and the description data score according to a fourth rule to generate the unified line score for the product line, determine whether the new product corresponds to a new product line based on the unified line scores of the plurality of product lines, and in the event that the new product does not correspond to a new product line, select a matching product line from the plurality of product lines for the new product based on the unified line scores of each of the plurality of product lines, update the product line database to associate the new product with the matching product line, and enforce pricing consistency rules for products within each product line in the product line database.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for rule-based automated retail product line linkage, the system comprising:
a product line database comprising product line data for a plurality of product lines, wherein product line data comprises line categorical data, line numerical data, and line description data; and
a control circuit coupled to the product line database and configured to:
retrieve product data for a new product, the product data comprising product categorical data, product numerical data, and product description data;
calculate unified line scores for each of the plurality of product lines in the product line database, wherein a unified line score for a product line is determined with a rule-based scoring engine configured to:
determine a categorical data score by comparing the product categorical data and the line categorical data associated with the product line according to a first rule;
determine a numerical data score by comparing the product numerical data and the line numerical data associated with the product line according to a second rule;
determine a description data score by comparing the line description data associated with the product line and the product description data according to a third rule; and
combine the categorical data score, the numerical data score, and the description data score according to a fourth rule to generate the unified line score for the product line;
determine whether the new product corresponds to a new product line based on the unified line scores of the plurality of product lines;
in the event that the new product does not correspond to a new product line, select a matching product line from the plurality of product lines for the new product based on the unified line scores of each of the plurality of product lines;
update the product line database to associate the new product with the matching product line; and
enforce pricing consistency rules for products within each product line in the product line database.

2. The system of claim 1, wherein the product categorical data comprises one or more of a brand identifier, a vendor identifier, a fineline number, and a department subcategory number.

3. The system of claim 1, wherein the first rule comprises weighting rules for two or more features of categorical data.

4. The system of claim 1, wherein the product numerical data comprises one or more of package count, weight, volume, height, width, and length.

5. The system of claim 1, wherein the second rule comprises an equation for determining a distance metric between the line numerical data and the product numerical data.

6. The system of claim 1 wherein the product description data comprises text descriptions and the third rule comprises a cosine similarity comparison algorithm.

7. The system of claim 1, wherein the fourth rule comprises a weighing rule for combining the categorical data score, the numerical data score, and the description data score into the unified line score.

8. The system of claim 1, wherein whether the new product corresponds to a new product line is determined based on an anomaly detection algorithm.

9. The system of claim 1, wherein line categorical data, line numerical data, and line description data of a product line corresponds to product categorical data, product numerical data, and product description data of a representative product in the product line.

10. The system of claim 1, wherein at least one of the first rule, the second rule, the third rule, and the fourth rule differs for product lines in different product categories.

11. A method for rule-based automated retail product line linkage, the method comprising:
retrieving product data for a new product, the product data comprising product categorical data, product numerical data, and product description data;
retrieving product line data for a plurality of product lines from a product line database, wherein product line data comprises line categorical data, line numerical data, and line description data;
calculating, with a control circuit, unified line scores for each of the plurality of product lines in the product line database, wherein a unified line score for a product line is determined with a rule-based scoring engine configured to:
determine a categorical data score by comparing the product categorical data and the line categorical data associated with the product line according to a first rule;
determine a numerical data score by comparing the product numerical data and the line numerical data associated with the product line according to a second rule;
determine a description data score by comparing the line description data associated with the product line and the product description data according to a third rule; and
combine the categorical data score, the numerical data score, and the description data score according to a fourth rule to generate the unified line score for the product line;
determining, with the control circuit, whether the new product corresponds to a new product line based on the unified line scores of the plurality of product lines;
in the event that the new product does not correspond to a new product line, selecting, with the control circuit, a matching product line from the plurality of product lines for the new product based on the unified line scores of each of the plurality of product lines;
updating the product line database to associate the new product with the matching product line; and
enforcing pricing consistency rules for products within each product line in the product line database.

12. The method of claim 11, wherein the product categorical data comprises one or more of a brand identifier, a vendor identifier, a fineline number, and a department subcategory number.

13. The method of claim 11, wherein the first rule comprises weighting rules for two or more features of categorical data.

14. The method of claim 11, wherein the product numerical data comprises one or more of package count, weight, volume, height, width, and length.

15. The method of claim 11, wherein the second rule comprises an equation for determining a distance metric between the line numerical data and the product numerical data.

16. The method of claim 11 wherein the product description data comprises text descriptions and the third rule comprises a cosine similarity comparison algorithm.

17. The method of claim 11, wherein the fourth rule comprises a weighing rule for combining the categorical data score, the numerical data score, and the description data score into the unified line score.

18. The method of claim 11, wherein whether the new product corresponds to a new product line is determined based on an anomaly detection algorithm.

19. The method of claim 11, wherein line categorical data, line numerical data, and line description data of a product line corresponds to product categorical data, product numerical data, and product description data of a representative product in the product line.

20. The method of claim 11, wherein at least one of the first rule, the second rule, the third rule, and the fourth rule differs for product lines in different product categories.

21. An apparatus for rule-based automated retail product line linkage, the apparatus comprising: a non-transitory storage medium storing a set of computer-readable instructions; and
a control circuit configured to execute the set of computer-readable instructions which causes the control circuit to:
retrieve product data for a new product, the product data comprising product categorical data, product numerical data, and product description data;
retrieve product line data for a plurality of product lines from a product line database, wherein product line data comprises line categorical data, line numerical data, and line description data;
calculate unified line scores for each of the plurality of product lines in the product line database, wherein a unified line score for a product line is determined with a rule-based scoring engine configured to:
determine a categorical data score by comparing the product categorical data and the line categorical data associated with the product line according to a first rule;
determine a numerical data score by comparing the product numerical data and the line numerical data associated with the product line according to a second rule;
determine a description data score by comparing the line description data associated with the product line and the product description data according to a third rule; and
combine the categorical data score, the numerical data score, and the description data score according to a fourth rule to generate the unified line score for the product line;
determine whether the new product corresponds to a new product line based on the unified line scores of the plurality of product lines;
in the event that the new product does not correspond to a new product line, select a matching product line from the plurality of product lines for the new product based on the unified line scores of each of the plurality of product lines;
update the product line database to associate the new product with the matching product line; and
enforce pricing consistency rules for products within each product line in the product line database.
